(19) United States
(12) Patent Application Publication
(10) Pub. No.: US 2016/0306349 A1
(43) Pub. Date: Oct. 20, 2016

(54) APPARATUS AND METHOD FOR REMOTELY MANEUVERING A DEVICE

(71) Applicant: LIFEJOYS, INC., Kirkland, WA (US)

(72) Inventor: Perry Lau, Kirkland, WA (US)

(21) Appl. No.: 14/686,719

(22) Filed: Apr. 14, 2015

(51) Int. Cl. G05D 1/00

(52) U.S. Cl. CPC G05D 1/0011

(57) ABSTRACT

Embodiments of apparatuses and methods to remotely maneuver a movable device are described. In embodiments, an apparatus may include an elongated body having a distal end and a proximal end, and a user input device coupled to the elongated body to receive inputs from a user. The apparatus may further include a sensor to sense a disposition and a movement of the distal end in relation to the proximal end, and a remote maneuver module coupled to the elongated body to receive a first input from the user input device and a second input from the sensor, and to translate the first input or the second input into one or more commands to maneuver a movable device. Other embodiments may be described and/or claimed.

### FIELD OF THE INVENTION

The present disclosure relates generally to the technical field of computing, and more particularly, to apparatuses and methods for remotely maneuvering a movable device.

### BACKGROUND

The background description provided herein is for the purpose of generally presenting the context of the disclosure. Unless otherwise indicated herein, the materials described in this section are not prior art to the claims in this application and are not admitted to be prior art or suggestions of the prior art, by inclusion in this section.

Radio control (RC) allows a user to remotely control a device using radio signals from a radio transmitter. Many types of vehicles may be installed with RC systems to become radio-controlled models (RC models), such as cars, boats, planes, and even helicopters and scale railway locomotives. RC models steerable with the use of radio control have brought great joys to many consumers, especially youth.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a schematic diagram illustrating an example system for remotely maneuvering a movable device, incorporating aspects of the present disclosure, in accordance with various embodiments.

FIGS. 2A-2C are schematic diagrams illustrating several examples of controllers for remotely maneuvering a movable device, incorporating aspects of the present disclosure, in accordance with various embodiments.

FIGS. 3A-3D are schematic diagrams illustrating several examples of user input unit configuration on a controller, incorporating aspects of the present disclosure, in accordance with various embodiments.

FIG. 4 is a schematic diagram illustrating an example component architecture of the controller, incorporating aspects of the present disclosure, in accordance with various embodiments.

FIG. 5 is a flow diagram of an example process for remotely maneuvering a movable device, which may be practiced by an example apparatus, incorporating aspects of the present disclosure, in accordance with various embodiments.

FIG. 6 illustrates an example computing device suitable for practicing the disclosed embodiments, in accordance with various embodiments.

FIG. 7 illustrates an article of manufacture having programming instructions, incorporating aspects of the present disclosure, in accordance with various embodiments.

### DETAILED DESCRIPTION

Embodiments of apparatuses and methods to remotely maneuver a movable device are described herein. In embodiments, an apparatus may include an elongated body having a distal end and a proximal end, and a first user input device and a second user input device coupled to the elongated body on opposite sides of the elongated body. The apparatus may further include a sensor to sense a disposition and a movement of the distal end in relation to the proximal end, and a remote maneuver module to receive inputs from the first user input device, the second user input device, or the sensor, and translate the inputs into one or more maneuver commands to maneuver a movable device. These and other aspects of the present disclosure will be more fully described below.

In the following detailed description, reference is made to the accompanying drawings, which form a part hereof, wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). Where the disclosure recites “a” or “a first” element or the equivalent thereof, such disclosure includes one or more such elements, neither requiring nor excluding two or more such elements. Further, ordinal indicators (e.g., first, second, or third) for identified elements are used to distinguish between the elements, and do not indicate or imply a required or limited number of such elements, nor do they indicate a particular position or order of such elements unless otherwise specifically stated.

The description may use the phrases “in one embodiment,” “in an embodiment,” “in another embodiment,” “in embodiments,” “in various embodiments,” or the like, which may each refer to one or more of the same or different embodiments. Furthermore, the terms “comprising,” “including,” “having,” and the like, as used with respect to embodiments of the present disclosure, are synonymous.

In embodiments, the term “module” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable components that provide the described functionality. In embodiments, a module may be implemented in firmware, hardware, software, or any combination of firmware, hardware, and software.

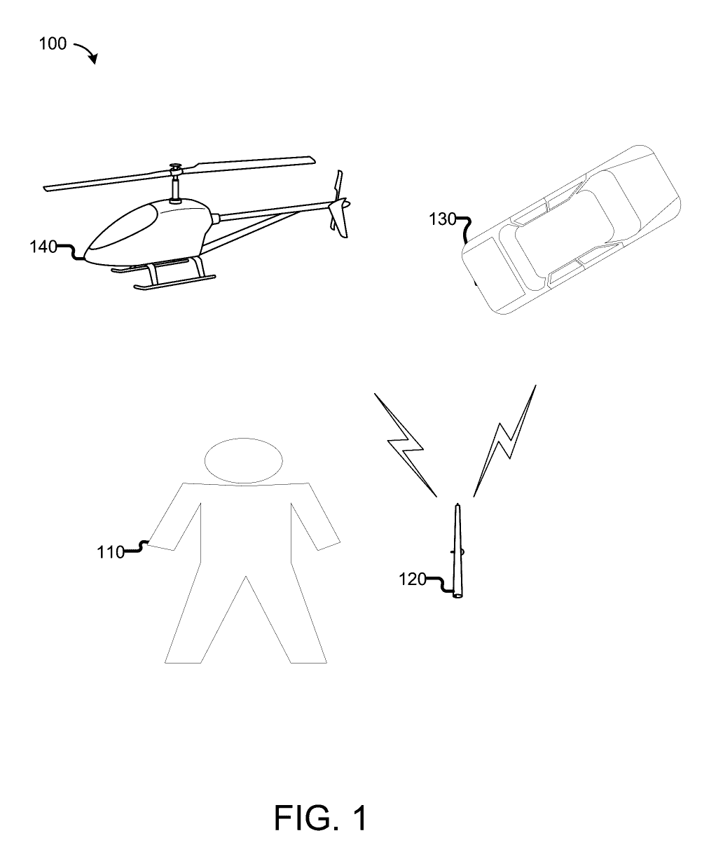

Referring now to FIG. 1, an example system for remotely maneuvering a movable device, in accordance with various embodiments, is illustrated. In various embodiments, system 100 may include controller 120 to be operated by a user 110. Moreover, system 100 may include helicopter 140, vehicle 130, or other movable objects (not shown) that may be remotely maneuvered. In various embodiments, user 110 may use controller 120 to send one or more maneuver commands to remotely control a disposition and a course of helicopter 140 or vehicle 130 in a two-dimensional space or a three-dimensional space.

In some embodiments, helicopter 140 may be a radio-controlled model aircraft (RC aircraft or RC plane). Helicopter 140 may be a flying machine that is controlled remotely by controller 120. In some embodiments, controller 120 may have an elongated pen-like form factor, thus may be conveniently handled by one hand of user 110.

In various embodiments, controller 120 may send maneuver commands to control servomechanisms (servos) in helicopter 140, which adjust the motor in helicopter 140 or move the control surfaces in helicopter 140 based on the maneuver commands, thus control the movement of helicopter 140.

In various embodiments, vehicle 130 may be a remote-controlled vehicle that may be remotely controlled by controller 120. In some embodiments, vehicle 130 may be a radio controllable device, an infrared controllable device, or controllable based on other wireless communication technologies available in controller 120.

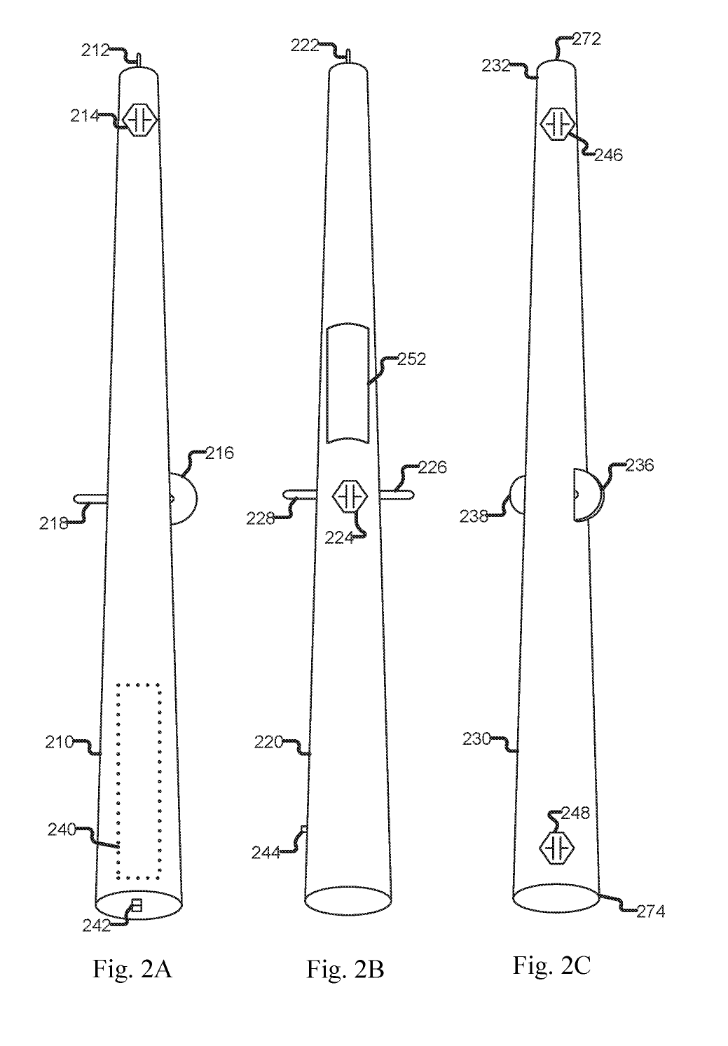

In various embodiments, controller 120 may use maneuver commands to control the altitude of helicopter 140. In various embodiments, controller 120 may use maneuver commands to control the disposition and the course of helicopter 140 or vehicle 130. In various embodiments, controller 120 may include sensors, and may be configured to translate the sensor data into a user gesture to maneuver the speed or the course of helicopter 140 or vehicle 130. These and other aspects of controller 120 will be more fully described below in connection with FIGS. 2-7.

Referring now to FIGS. 2A-2C, several examples of controllers for remotely maneuvering a movable device, in accordance with various embodiments, are illustrated. In various embodiments, controllers may have an elongated body having a distal end and a proximal end. In some embodiments, the body of a controller may have a tubular or cylinder form factor. In other embodiments, the body of a controller may have different form factors, e.g., cone form factor or cubic form factor. In various embodiments, a controller may translate various user input or sensor data into one or more maneuver commands to maneuver a remote movable device.

Referring to FIG. 2A, controller 210 may be configured with antenna 212 extending from one end to transmit signals to a remote device, e.g., helicopter 140 or vehicle 130 in FIG. 1. In alternate embodiments, antenna 212 may be embedded within the body of controller 210. Controller 210 may include sensor 214, such as, but not limited to, a gyroscopic sensor or an accelerometer, to sense the disposition and the movement of controller 210.

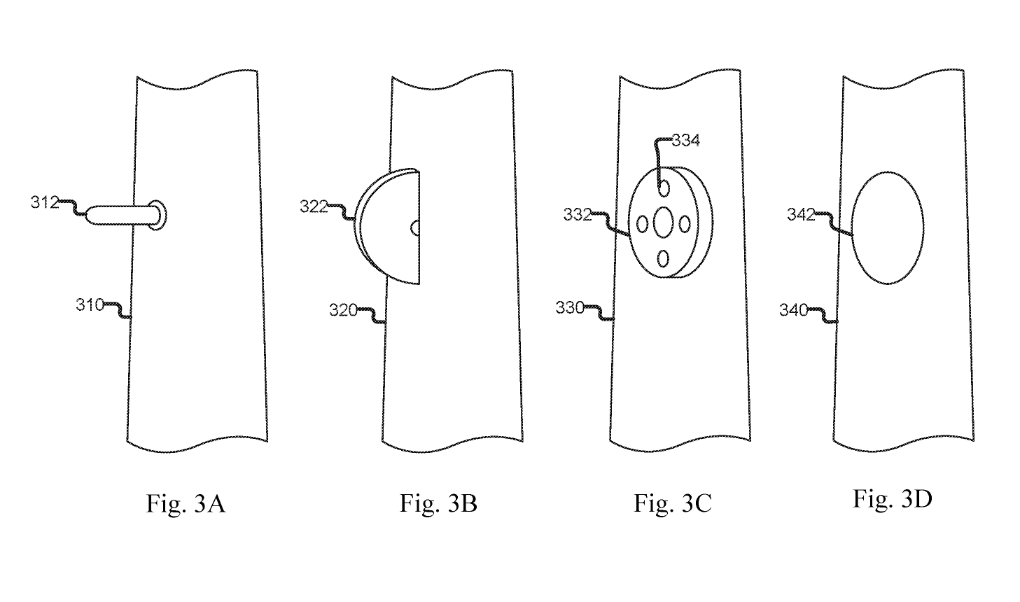

In one embodiment, controller 210 may further include wheel 216 and/or joystick 218 as various user input units to receive user inputs. Wheel 216 and joystick 218 may be arranged on opposite sides of the elongated tubular body of controller 210. Further, wheel 216 and joystick 218 may be configured in approximately the same distance to one end of controller 210, e.g., the distal end or the proximal end. In some embodiments, wheel 216 and joystick 218 may be situated within 2 inches. In some embodiments, wheel 216 and joystick 218 may be located near the middle of controller 210. Advantageously, when controller 210 is handled by one hand of a user, two fingers, e.g., the thumb and the index finger of the user, may simultaneously and independently control wheel 216 and joystick 218. Thus, in various embodiments, controller 210 may synthesize multiple inputs, e.g., from wheel 216, joystick 218, and sensor 214, into one or more maneuver commands to maneuver the remote device. Further aspects of wheel 216 and joystick 218 will be more fully described below in connection with FIG. 3.

In some embodiments, controller 210 may also include battery compartment 240 to hold a battery, e.g., a non-rechargeable alkaline or a rechargeable lithium-ion battery (Li-ion battery or LIB). Further, controller 210 may also include switch 242, which may be used to power on or off controller 210 by a user.

Referring now to FIG. 2B, in various embodiments, controller 220 may include antenna 222, sensor 224, joystick 226, joystick 228, display 252, and switch 244. Sensor 224 may be similar to sensor 214. In one embodiment, both user input units may be in the form of a joystick. However, joystick 226 and joystick 228 may have different sizes, shapes, lengths, or colors to be differentiated by a user. Similar to the arrangement of controller 210, joystick 226 and joystick 228 may be arranged on opposite sides of the elongated body of controller 220, and have approximately a same distance to one end of controller 220. Thus, when controller 220 is handled by one hand of a user, two fingers, e.g., the thumb and the index finger of the user, may simultaneously and independently control joystick 226 and joystick 228.

In one embodiment, display 252 may be a liquid-crystal display (LCD), which may display the disposition of controller 220 (e.g., the facing direction) or the interpreted gesture based on the movement of controller 220. In some embodiments, display 252 may also be used to display information related to the remote device, e.g., the flying parameters or battery status of helicopter 140, so that the user may issue appropriate maneuver commands accordingly.

Referring now to FIG. 2C, in various embodiments, controller 230 may include antenna 232, sensor 246, sensor 248, wheel 236, and wheel 238. In one embodiment, antenna 232 may be integrated into the metal shell of controller 230, e.g., when controller 230 has an elongated body. In one embodiment, both user input units may be in the form of a wheel or wheel. However, wheel 236 and wheel 238 may have different sizes, thicknesses, shapes, or colors to be differentiated by a user. Similar to the arrangement of controller 210, wheel 236 and wheel 238 may be arranged on opposite sides of the elongated body of controller 230, and have approximately a same distance to one end of controller 230. Thus, wheel 236 and wheel 238 may be handled by two fingers in one hand of a user, e.g., the thumb and the index finger of the user, simultaneously and independently.

Sensor 246 or sensor 248 may be similar to sensor 214, and may be used to sense the disposition and the movement of controller 230. In one embodiment, sensor 246 or sensor 248 may collectively detect the movement of distal end 272 in relation to the proximal end 274 of controller 230. As an example, when sensor 246 detects greater angular momentum than sensor 248 does, distal end 272 may be pivoting based on the proximal end 274. In some embodiments, information of the movement of distal end 272 in relation to the proximal end 274 may be translated into one or more maneuver commands to maneuver a remote device. In some embodiments, information of the movement of distal end 272 in relation to the proximal end 274 may be combined with user input from one or more user input units, e.g., wheel 236 and wheel 238, into one or more maneuver commands to maneuver a disposition and a course of the remote device.

In various embodiments, a controller may be manufactured in similar or different form factors as those depicted in FIG. 2 without departing from the principles disclosed herein. In various embodiments, other forms of user input units, e.g., control buttons, may also be used in place of joysticks, wheels, or touchpads depicted in FIG. 2 without departing from the principles disclosed herein. In various embodiments, user input units may be exchangeable among various controllers based on a particular product design. In various embodiments, user input units may be arranged in different configurations, e.g., locations, as those depicted in FIG. 2 without departing from the principles disclosed herein.

Referring now to FIGS. 3A-3D, several examples of user input unit configuration on a controller, in accordance with various embodiments, are illustrated. Many suitable user input units may be configured on a controller to receive mechanical or electrical user input.

Referring now to FIG. 3A, in some embodiments, user input unit on controller 310 may be configured as joystick 312. Joystick 312 may be an input device including a stick that pivots on a base. In some embodiments, movement sensors, pressure sensors, tension sensors, or other suitable sensors may be used to detect the movement of joystick 312. Sensors linked to joystick 312 may then report the angle or direction information related to the movement of the stick. Such sensor information may be used to control a remote device.

The joystick sensors trigger whenever the joystick moves. In some embodiments, joystick 312 may be an analog joystick, which has a continuous range of positional states. As an example, joystick 312 may use potentiometers to determine the position of the stick, thus its positional state. As another example, joystick 312 may use a Hall effect sensor to determine its positional state for improved reliability and reduced size. In other embodiments, joystick 312 may be a digital joystick, which gives only the on-off states of a group of switches corresponding to a direction of applied force, e.g., 8 cardinal directions.

Referring now to FIG. 3B, in some embodiments, joystick 312 may be two-dimensional, e.g., having two axes of movement. As an example, moving joystick 312 left or right signals movement along the X axis, and moving joystick 312 up or down signals movement along the Y axis. In other embodiments, joystick 312 may be three-dimensional, e.g., having three axes of movement. As an example, twisting joystick 312 clockwise or counter-clockwise signals movement along the Z axis in addition to previously described movement along the X and Y axes. When the controllable remote device (e.g., a helicopter) is movable in a three-dimensional space, the X, Y, and Z axes may respectively correspond to the remote device's roll, pitch, and yaw.

In some embodiments, user input unit on controller 320 may be configured as rotatable wheel 322. In some embodiments, wheel 322 may be configured to be perpendicular to the surface of controller 320. In various embodiments, a movement sensor may be used to detect the rotation of wheel 322, e.g., the direction of the rotation or the angular momentum of the rotation. In some embodiments, wheel 322 may have a threshold position that allows wheel 322 to conduct another kind of movement, e.g., click, when the wheel rotates beyond the threshold position. In some embodiments, wheel 322 may have a neutral position that allows wheel 322 to return to the neutral position without external forces, e.g., based on a spring connect to wheel 322.

In various embodiments, the rotation information may be used by controller 320 as a form of user input to control a remote device. In some embodiments, wheel 322 may have a non-circular shape, e.g., a square, a pentagon, a hexagon, a heptagon, an octagon, a nonagon, a decagon, or another type of polygon. In various embodiments, wheel-shaped user input device as used herein may be in any other shapes as long as it is rotatable, and its rotation information may be detected and measured. In some embodiments, wheel 322 may be rotated in any direction without any restriction. As an example, optical finger navigation (OFN) sensors may configured and positioned to sense rotation of wheel 322 without being mechanically bounded by the rotation of wheel 322.

Referring now to FIG. 3C, in some embodiments, user input unit on controller 330 may be configured as wheel 332. Wheel 332 may be configured to be tangential to the surface of controller 330. Wheel 332 may function similar to wheel 322 in some embodiments, in which the rotation information of wheel 332 may be translated into one or more maneuver commands to maneuver a remote device. In some embodiments, wheel 332 may function like a rotary dial with multiple holes 334 arranged in a circular layout. A user may use one finger to rotate wheel 332 from one position to another, clockwise or counter-clockwise based on the circular holes. Controller 330 may translate such rotation into respective maneuver commands, e.g., based on the rotation pattern.

Referring now to FIG. 3C, in some embodiments, user input unit on controller 340 may be configured as touchpad 342. Touchpad 342 may be configured to conform to the surface of controller 340, e.g., with a similar curvature. In some embodiments, touchpad 342 may be configured to be slightly elevated from the surface of controller 340. In other embodiments, touchpad 342 may be configured as a concave surface sunk onto the surface of controller 340.

In some embodiments, pressure sensors (not shown), tactile sensors (not shown), capacitive sensors (not shown), or other suitable sensors may be arranged with touchpad 342 to sense how a finger interacts with touchpad 342. As an example, these sensors may detect the location of touch, the pressure of touch, the frequency of tapping, the movement pattern of fingers, e.g., sliding motion, circular motion, etc. In one embodiment, capacitive sensors may be used to detect the changes to the electric field caused by finger gestures on or near the outer surface of touchpad 342. Therefore, controller 340 may translate the finger movement information into one or more maneuver commands to maneuver a remote device.

In other embodiments, other different user input units, e.g., with different form factors or technologies, may also be configured on a controller to receive user inputs to be converted into maneuver commands. As an example, a trackball, consisting of a ball held by a socket containing sensors to detect a rotation of the ball, may be used in the place of joystick 312 in FIG. 3A, wheel 322 in FIG. 3B, wheel 332 in FIG. 3C, or touchpad 342 in FIG. 3D. Similarly, user input units in other forms factors, such as a button or a trigger, may also be used.

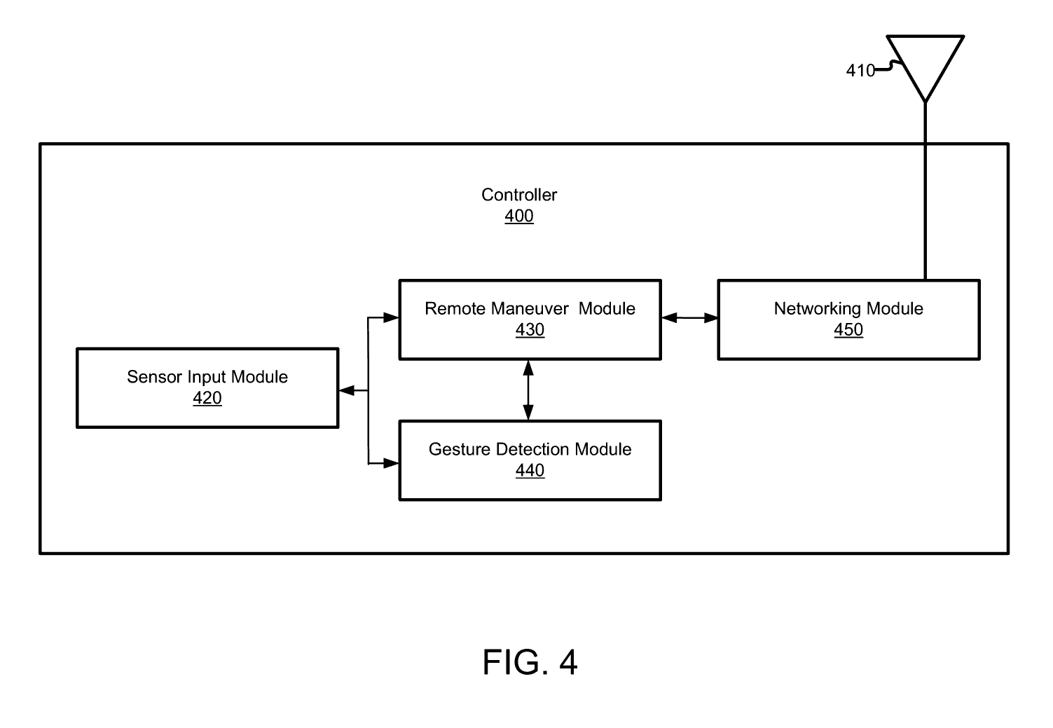

FIG. 4 is a schematic diagram illustrating an example component architecture of controller 400, incorporating aspects of the present disclosure, in accordance with various embodiments. In various embodiments, controller 400 may include antenna 410, sensor input module 420, remote maneuver module 430, gesture detection module 440, and networking module 450, coupled to each other, e.g., as shown in FIG. 4.

In various embodiments, controller 400 may include antenna 410 and one or more wireless transceivers (not shown). Antenna 410 may, in various embodiments, include one or more directional or omni-directional antennas such as dipole antennas, monopole antennas, patch antennas, loop antennas, microstrip antennas, and/or other types of antennas suitable for reception of radio frequency (RF) or other wireless communication signals. Although FIG. 4 depicts a single antenna, in various embodiments, controller 400 may include additional antennas. In other embodiments, controller 400 may include additional hardware for wireless communication. The underlying communication hardware, such as antenna 410, may be coupled to networking module 450.

In embodiments, networking module 450 may communicate with remote maneuverable devices via wireless communication. In embodiments, networking module 450 may also communicate with other computing devices. Networking module 450 may include one or more transceivers, such as a line-of-sight wireless transmitter, an infrared transmitter, or a radio frequency transceiver. Networking module 450 may be configured to receive and transmit wireless signals from and to another remote maneuverable or computing device, e.g., an RF model, and may extract information from wireless signals received from other wireless devices. In some embodiments, wireless signals may include information about maneuver commands to maneuver a remote device. In some embodiments, wireless signals may include information about the present disposition or motion information of the remote device, such as the direction information or flying parameters of the remote device. In other embodiments, wireless signals to and from other computing devices may include information, such as firmware or software updates for controller 400. In embodiments, networking module 450 may support Bluetooth®, WiFi, Long-Term Evolution (LTE) or other wireless communications.

In various embodiments, sensor input module 420 may receive data from various sensors, such as sensor 214 of FIG. 2A, 224 or 246 of FIG. 2B, or 248 of FIG. 2C, relating to the disposition or movement of controller 400, e.g., a movement of one end in relation to the other end of controller 400 when controller 400 has a prolonged form factor, or a gesture made based on the movement of controller 400. In various embodiments, sensor input module 420 may receive data from various sensors, such as various sensors discussed in connection with FIGS. 3A-3D to receive user inputs from various user input units on controller 400.

In various embodiments, sensor input module 420 may send sensor data to gesture detection module 440. A gesture may be a form of non-verbal communication indicated by a user using controller 400, e.g., based on the disposition of controller 400 or a movement pattern of controller 400. In various embodiments, gesture detection module 440 may utilize sensor data to recognize or interpret gestures. As an example, a particular disposition of controller 400, e.g., facing north, may be interpreted as a gesture to adjust the remote device to face north. As another example, a circular motion of controller 400 may be interpreted as a circular gesture.

In some embodiments, gesture detection module 440 may be programmed to recognize a set of personalized gestures from a particular user or designed to a particular remote device. As an example, in the case of controlling an RF helicopter, a waving motion of controller 400 may be programmed as a gesture to call back the remote device to its starting position.

In various embodiments, both sensor input module 420 and gesture detection module 440 may communicate with remote maneuver module 430. Remote maneuver module 430 may analyze the sensor data as well as the interpreted gesture, and translate them into one or more maneuver commands to maneuver the remote device.

In some embodiments, remote maneuver module 430 may translate sensor data into a maneuver command to control the disposition of the remote device. As an example, a particular disposition of controller 400, e.g., facing north, may be interpreted as a maneuver command to adjust the remote device to face north.

In some embodiments, remote maneuver module 430 may translate a user gesture into a maneuver command to control the speed or the course of the remote device. As an example, a circular gesture, e.g., based on a circular motion of controller 400, may be interpreted as a maneuver command to enable the remote device to conduct a circular motion. Therefore, remote maneuver module 430 may use the one or more maneuver commands to control a disposition and a course of the remote device in a physical three-dimensional space. In various embodiments, remote maneuver module 430 may send these maneuver commands via networking module 450.

In some embodiments, remote maneuver module 430 may translate sensor data into a maneuver command to control an altitude of the remote device. As an example, sensor data from wheel 322 of FIG. 3B may be translated into altitude controlling commands. For instance, rotating upward may be translated into a maneuver command to increase the altitude of the remote device. As another example, sensor data from wheel 332 of FIG. 3C may be translated into preconfigured altitude controlling commands. For instance, a particular hole 334 may correspond to a particular target altitude for the remote device to fly.

In some embodiments, remote maneuver module 430 may translate a combination of at least two different inputs from controller 400 into the one or more maneuver commands. In some embodiments, one input may be received from sensor 214 of FIG. 2A, 224 of FIG. 2B, 246 or 248 of FIG. 2C relating to the disposition or movement of controller 400, while the other input may be received from various sensors discussed in connection with various user input units on controller 400. As an example, pushing joystick 312 of FIG. 3A upward in combination with a circular gesture may be translated into a maneuver command to control a remote device entering into a spiral ascending mode. Similarly, pushing joystick 312 downward in combination with a circular gesture may be translated into a maneuver command to control the remote device entering into a spiral descending mode. Therefore, with multiple sensor input data, remote maneuver module 430 may enable the remote device to perform various advanced acrobatic movements.

In various embodiments, sensor input module 420, remote maneuver module 430, gesture detection module 440, and networking module 450 may be implemented in hardware, firmware, software, or any combination of hardware, firmware, and software. In various embodiments, controller 400 may be configured differently from FIG. 4. As an example, gesture detection module 440 may be integrated into sensor input module 420. As another example, gesture detection module 440 may be integrated into remote maneuver module 430.

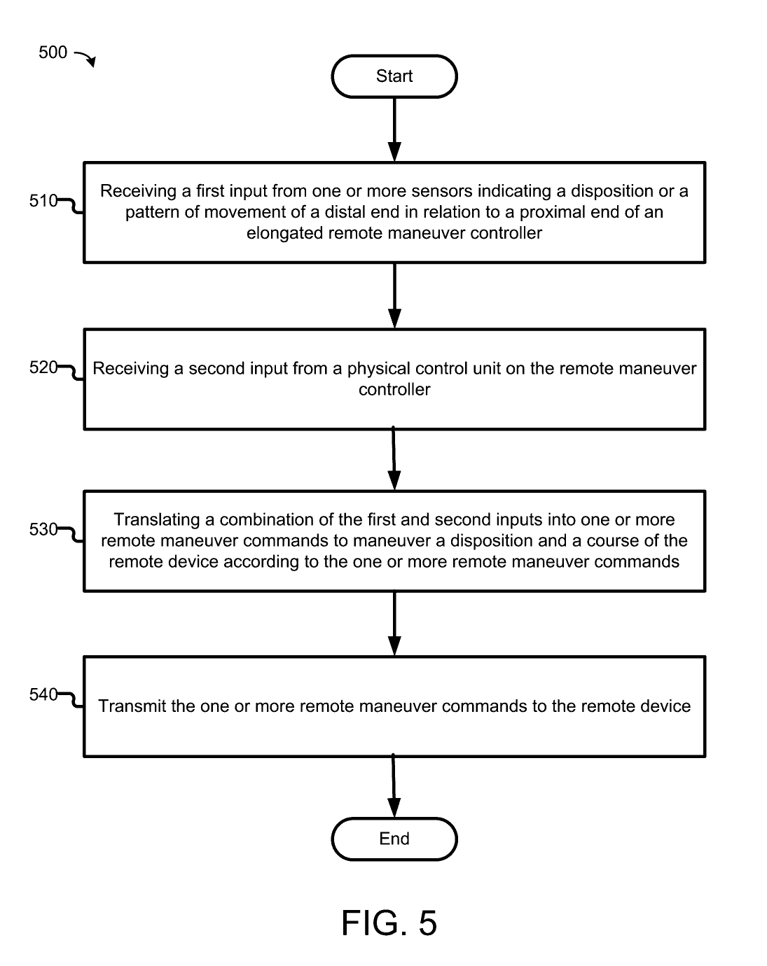

Referring now to FIG. 5, it is a flow diagram of an example process for remotely maneuver a movable device that may be practiced by an example apparatus, incorporating aspects of the present disclosure, in accordance with various embodiments. As shown, process 500 may be performed by controller 120 of FIG. 1, or controller 210 of FIG. 2A, 220 of FIG. 2B, or 230 of FIG. 2C to implement one or more embodiments of the present disclosure. In alternate embodiments, process 500 may be performed with more or fewer operations, or in different order.

In embodiments, the process may begin at block 510, where a first input from one or more sensors indicating a disposition or a pattern of movement of a distal end in relation to a proximal end of an elongated remote maneuver controller may be received, e.g., by sensor input module 420 of FIG. 4. In some embodiments, the first input may be received from one gyroscopic sensor or an accelerometer on the remote maneuver controller.

Next, at block 520, a second input may be received from a physical control unit on the remote maneuver controller, e.g., by sensor input module 420 of FIG. 4. In some embodiments, the second input may be received from a wheel-like controlling unit or a joystick-like controller unit on the remote maneuver controller. The respective sensor (e.g., a pressure sensor) associated with the wheel-like controlling unit or the joystick-like controller unit may provide the second input to the sensor input module. In some embodiments, the second input may be received from a tactile sensor or a capacitive sensor associated with a touchpad on the remote maneuver controller. In this case, the second input may indicate a location, a pressure, or a moving pattern detected by the tactile sensor or the capacitive sensor based on how a user's finger interacts with the touchpad.

Next, at block 530, a combination of the first and second inputs may be translated into one or more maneuver commands to maneuver a disposition and a course of a remote movable device, e.g., by remote maneuver module 430 of FIG. 4. In some embodiments, the first input may be translated into a speed or the course of the remote device. In some embodiments, the second input may be translated into a maneuver command to control an altitude or the disposition of the movable device. In some embodiments, the first input may indicate a gesture based on the pattern of movement of one end of the remote maneuver controller. In this case, the gesture and the second input may be translated together into one or more maneuver commands.

Next, at block 540, the one or more maneuver commands may be transmitted to the remote movable device, e.g., by networking module 450 of FIG. 4. Networking module 450 may use any suitable hardware and software to communicate with a movable device directly or indirectly over one or more network(s). In some embodiments, the one or more maneuver commands may be sent using a radio frequency (RF) signal, e.g., with identified radio frequencies that range from 3 Hz to 300 GHz. In various embodiments, the one or more maneuver commands may be sent using near field communication, optical communications, wireless communication, or other similar networking technologies to the movable device. In some embodiments, the movable device may be a remotely controllable toy, such as a toy vehicle, e.g., a helicopter or a car.

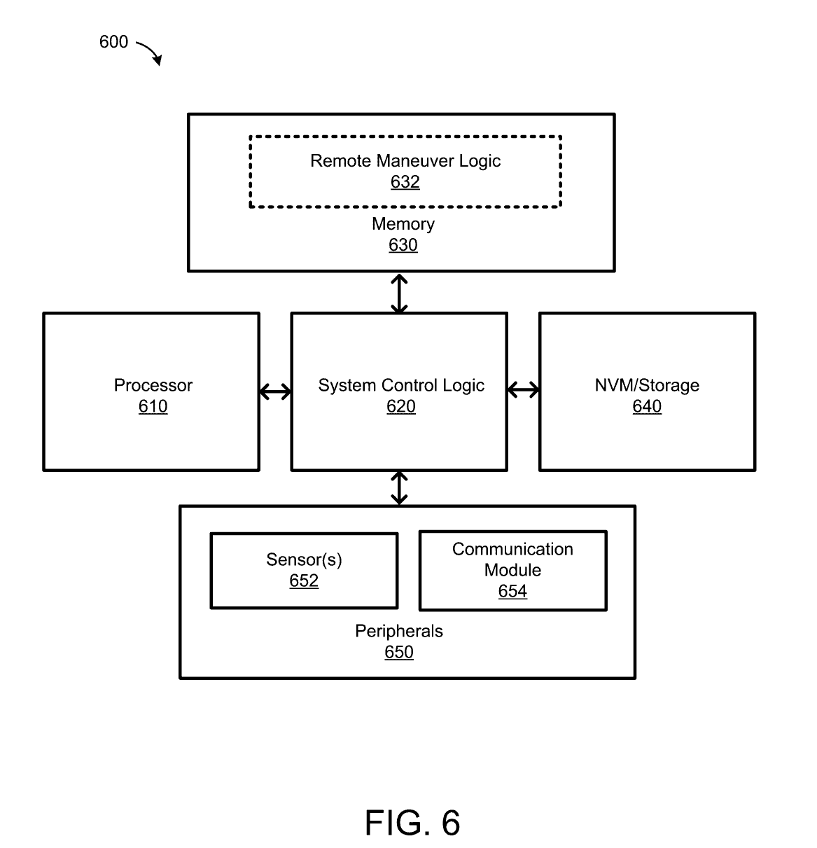

FIG. 6 illustrates an embodiment of a computing device 600 suitable for practicing embodiments of the present disclosure. As illustrated, computing device 600 may include system control logic 620 coupled to one or more processor(s) 610, to system memory 630, to non-volatile memory (NVM)/storage 640, and to one or more peripherals 650. In various embodiments, the one or more processors 610 may include a processor core. In various embodiments, elements 610-650 are encased in a body suitable for handheld operation by a user, such as, but not limited to, the form factors described with reference to FIG. 1 and FIG. 2.

In embodiments, peripherals 650 may include sensors 652, similar to earlier described sensor 214 in connection with FIG. 2A, 224 in connection with FIG. 2B, 246, or 248 in connection with FIG. 2C, which may be disposed in a particular arrangement, configured to enable an apparatus, e.g., controller 210, 220, or 230, to receive information of a disposition or a pattern of movement of a distal end in relation to a proximal end of an elongated remote maneuver controller. In embodiments, sensors 652 may also include tactile sensors or capacitive sensors, e.g., disposed under touchpad 342 of FIG. 3D, to detect a location, a pressure, or a moving pattern of a finger on touchpad 342. In other embodiments, other types of sensors may be used, e.g., to detect the pressure or tension related to a joystick on a controller.

In embodiments, peripherals 650 may also include communication module 654 within peripherals 650. Communication module 654 may provide an interface for computing device 600 to communicate over one or more network(s) and/or with any other suitable device. Communication module 654 may include any suitable hardware and/or firmware, such as a network adapter, one or more antennas, wireless interface(s), and so forth.

In various embodiments, communication module 654 may include suitable hardware and software to communicate with a movable device using a radio frequency (RF) signal, e.g., with identified radio frequencies that range from 3 Hz to 300 GHz. In various embodiments, communication module 654 may include an interface for computing device 600 to use near field communication (NFC), optical communications, or other similar technologies to communicate directly (e.g., without an intermediary) with a movable device.

In various embodiments, communication module 654 may interoperate with radio communications technologies such as, for example, Wideband Code Division Multiple Access (WCDMA), Global System for Mobile Communications (GSM), LTE, Bluetooth®, Zigbee, and the like, to communicate with a movable device directly or indirectly via an intermediator, such as a server.

In some embodiments, system control logic 620 may include any suitable interface controllers to provide for any suitable interface to the processor(s) 610 and/or to any suitable device or component in communication with system control logic 620. System control logic 620 may also interoperate with a display (e.g., display 252 on controller 220 of FIG. 2B) for the display of information, such as to a user. In various embodiments, the display may include one of various display formats and forms, such as, for example, liquid-crystal displays, e-ink displays, projection displays.

In some embodiments, system control logic 620 may include one or more memory controller(s) (not shown) to provide an interface to system memory 630. System memory 630 may be used to load and store data and/or instructions, for example, for computing device 600. System memory 630 may include any suitable volatile memory, such as suitable dynamic random access memory (DRAM), for example.

In some embodiments, system control logic 620 may include one or more input/output (I/O) controller(s) (not shown) to provide an interface to NVM/storage 640 and peripherals 650. NVM/storage 640 may be used to store data and/or instructions, for example. NVM/storage 640 may include any suitable non-volatile memory, such as flash memory, for example, and/or may include any suitable non-volatile storage device(s), such as one or more hard disk drive(s) (HDD), one or more solid-state drive(s). NVM/storage 640 may include a storage resource that is physically part of a device on which computing device 600 is installed or it may be accessible by, but not necessarily a part of, computing device 600. For example, NVM/storage 640 may be accessed by computing device 600 over a network via communication module 654.

In embodiments, system memory 630, NVM/storage 640, and system control logic 620 may include, in particular, temporal and persistent copies of remote maneuver logic 632. The remote maneuver logic 632 may include instructions that, when executed by at least one of the processor(s) 610, result in computing device 600 remotely maneuvering a movable device in a process such as, but not limited to, process 500 of FIG. 5 or any other processes described in connection with FIGS. 1-4.

In some embodiments, at least one of the processor(s) 610 may be packaged together with system control logic 620 and/or remote maneuver logic 632. In some embodiments, at least one of the processor(s) 610 may be packaged together with system control logic 620 and/or remote maneuver logic 632 to form a System in Package (SiP). In some embodiments, at least one of the processor(s) 610 may be integrated on the same die with system control logic 620 and/or remote maneuver logic 632. In some embodiments, at least one of the processor(s) 610 may be integrated on the same die with system control logic 620 and/or remote maneuver logic 632 to form a System on Chip (SoC). In some embodiments, sensors 652 may be integrated on the same die with one or more of the processor(s) 610.

Depending on which modules of controller 210, 220, or 230 in connection with FIG. 2 are hosted by computing device 600, the capabilities and/or performance characteristics of processors 610, system memory 630, and so forth may vary. In various implementations, computing device 600 may be a remote controller with a tubular form factor, an elongated rectangle form factor, or other suitable form factors, enhanced with the teachings of the present disclosure. In embodiments, the placement of the different modules in FIG. 6 and/or how they are clustered with other modules may be different from what is illustrated in FIG. 6.

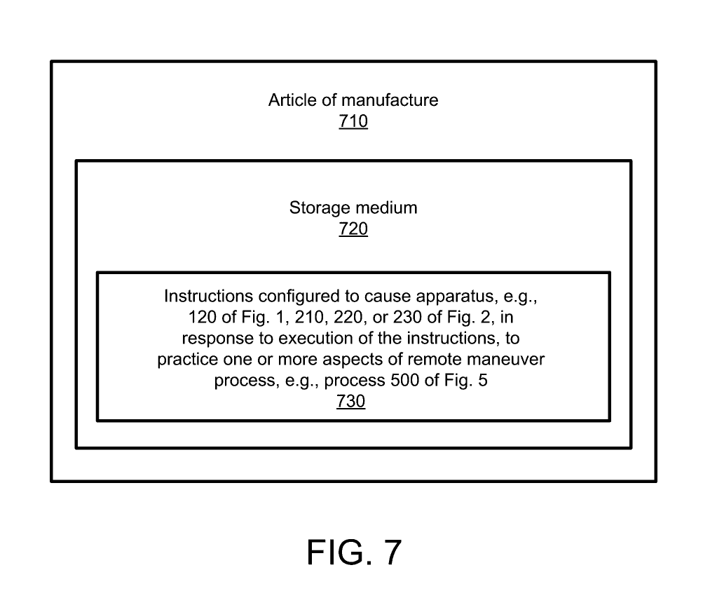

FIG. 7 illustrates an article of manufacture 710 having programming instructions, incorporating aspects of the present disclosure, in accordance with various embodiments. In various embodiments, an article of manufacture may be employed to implement various embodiments of the present disclosure. As shown, the article of manufacture 710 may include a computer-readable non-transitory storage medium 720 where instructions 730 are configured to practice embodiments of or aspects of embodiments of any one of the processes described herein. The storage medium 720 may represent a broad range of persistent storage media known in the art, including but not limited to flash memory, dynamic random access memory, static random access memory, an optical disk, a magnetic disk, etc. Instructions 730 may enable an apparatus, in response to their execution by the apparatus, to perform various operations described herein. For example, storage medium 720 may include instructions 730 configured to cause an apparatus, e.g., controller 120 of FIG. 1, controller 210 of FIG. 2A, 220 of FIG. 2B, or 230 of FIG. 2C, or computing device 600 of FIG. 6, to practice some or all aspects of remotely maneuvering a movable device, e.g., according to the process 500 of FIG. 5, in accordance with embodiments of the present disclosure. In embodiments, computer-readable storage medium 720 may include one or more computer-readable non-transitory storage medium. In other embodiments, computer-readable storage medium 720 may be transitory, such as signals, encoded with instructions 730.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. For example, as noted earlier, while for ease of understanding the disclosure hereinabove primarily described an apparatus with a metal band on the side to demonstrate various embodiments, this disclosure may also be embodied in an apparatus without a metal band on the side. Therefore, it is manifestly intended that embodiments described herein be limited only by the claims.

The following paragraphs describe examples of various embodiments.

Example 1 is an apparatus to remotely maneuver a movable device. The apparatus may include an elongated body having a distal end and a proximal end; a user input device coupled to the elongated body to receive inputs from a user; a sensor coupled to the elongated body to sense a disposition or a movement of the distal end in relation to the proximal end; and a remote maneuver module coupled to the elongated body to receive a first input from the user input device and a second input from the sensor, and to translate the first input or the second input into one or more commands to maneuver a movable device.

Example 2 may include the subject matter of Example 1, wherein the user input device is a first user input device, the apparatus may further include a second user input device coupled to the elongated body; wherein the first user input device and the second user input device are coupled to the elongated body on opposite sides of the elongated body, the first and second input devices having approximately a same distance to the proximal end; wherein the remote maneuver module is further to receive a third input from the second user input device, and to translate the first input, the second input, or the third input into the one or more commands to maneuver the movable device.

Example 3 may include the subject matter of Example 2, and may further specify that the apparatus is a remote toy controller, and the remote maneuver module is to translate a combination of at least two inputs from the first user input, the second input, and the third input into the one or more commands.

Example 4 may include the subject matter of any one of Examples 1-3, and further include an antenna, coupled to the remote maneuver module, to facilitate the one or more commands to be transmitted to the movable device; a switch, coupled to the remote maneuver module, to enable the remote maneuver module to be powered on or off; or a battery compartment, enclosed in the elongated body, to accommodate a battery.

Example 5 may include the subject matter of any one of Examples 1-4, and may further specify that the first or second user input device includes a wheel, a joystick, or a touchpad.

Example 6 may include the subject matter of any one of Examples 1-5, and may further specify that the sensor comprises a selected one of a gyroscopic sensor or an accelerometer.

Example 7 may include the subject matter of any one of Examples 1-6, and may further specify that the remote maneuver module is to use the one or more commands to control a disposition and a course of the movable device in a physical three-dimensional space.

Example 8 may include the subject matter of any one of Examples 1-7, and may further specify that the remote maneuver module is to translate the first or second input into a maneuver command to control an altitude of the movable device.

Example 9 may include the subject matter of any one of Examples 1-8, and may further specify that the remote maneuver module is to translate the first or second input into a maneuver command to control the disposition of the movable device.

Example 10 may include the subject matter of any one of Examples 1-9, and may further specify that the remote maneuver module is to translate the disposition or the movement of the distal end in relation to the proximal end into a user gesture to maneuver a speed or the course of the movable device.

Example 11 is a method for remotely maneuvering a movable device. The method may include receiving, by a controller, a first input from one or more sensors indicating a disposition or a pattern of movement of a distal end in relation to a proximal end of an elongated remote maneuver controller hosting the controller; receiving, by the controller, a second input from a physical control unit on the remote maneuver controller; translating, by the controller, a combination of the first and second inputs into one or more commands to maneuver a disposition and a course of a movable device; and transmitting or causing to be transmitted, by the controller, the one or more commands to the movable device.

Example 12 may include the subject matter of Example 11, and may further specify that receiving a first input comprises receiving the first input based on at least one gyroscopic sensor or an accelerometer on the elongated remote maneuver controller.

Example 13 may include the subject matter of Example 11 or 12, and may further specify that receiving the first input comprises receiving the first input indicating a gesture based on the pattern of movement of the distal end; wherein translating comprises translating the gesture and the second input into one or more commands.

Example 14 may include the subject matter of any one of Examples 11-13, and may further specify that receiving the second input comprises receiving the second input from a wheel or a joystick on the elongated remote maneuver controller.

Example 15 may include the subject matter of any one of Examples 11-14, and may further specify that receiving the second input comprises receiving the second input based on a tactile sensor or a capacitive sensor associated with a touchpad on the elongated remote maneuver controller.

Example 16 may include the subject matter of Examples 15, and may further specify that receiving the second input comprises receiving the second input based on a location, a pressure, or a moving pattern detected by the tactile sensor or the capacitive sensor associated with the touchpad.

Example 17 may include the subject matter of any one of Examples 11-16, and may further specify that translating comprises translating the first input into a speed or the course of the remote movable device.

Example 18 may include the subject matter of any one of Examples 11-17, and may further specify that translating the second input into a maneuver command to control an altitude or the disposition of the movable device.

Example 19 is a computer-readable storage medium having stored therein instructions configured to cause a device, in response to execution of the instructions by the device, to practice the subject matter of any one of Examples 11-18. The storage medium may be non-transient.

Example 20 is an apparatus to remotely maneuver a movable device. The apparatus may include means to practice the subject matter of any one of Examples 11-18.

Example 21 is a system for remotely maneuvering a movable device. The system may include a movable device and a remote controller to remotely maneuver the movable device. The remote controller may include an elongated body having a distal end and a proximal end; a first user input device and a second user input device coupled to the elongated body on opposite sides of the elongated body, the first and second input devices having approximately a same distance to the proximal end; a sensor coupled to the elongated body to sense a disposition and a movement of the distal end in relation to the proximal end; and a remote maneuver module, coupled to the elongated body, to receive a first input from the first user input device, a second input from the second user input device, or a third input from the sensor; wherein the remote maneuver module is to translate the first input, the second input, or the third input into one or more maneuver commands to maneuver the movable device.

Example 22 may include the subject matter of Example 21, and may further specify that the remote maneuver module is to use the one or more commands to control a disposition and a course of the movable device in a physical three-dimensional space.

Example 23 may include the subject matter of Example 21 or 22, and further specifies that the remote maneuver module is to translate a combination of at least two selected inputs from the first user input, the second input, and the third input into the one or more commands.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

1. An apparatus, comprising:
an elongated body having a distal end and a proximal end, wherein the elongated body is to be held by one hand of a user during operation;
a first and a second user input device on substantially opposite sides of the elongated body and coupled to the elongated body to receive inputs from a user;
a sensor coupled to the elongated body to sense a disposition or a movement of the distal end in relation to the proximal end;
one or more computer processors; and
a remote maneuver module communicatively coupled to the one or more processors and coupled to the elongated body to determine one or more commands to maneuver a movable device, wherein the remote maneuver module is to:
receive a first input from the first or the second user input device;
receive a second input from the sensor;
translate the first input or the second input into the one or more commands to maneuver the movable device;
wherein the one or more commands are to cause the location of the movable device to change.

2. The apparatus according to claim 1,
wherein the remote maneuver module is further to receive a third input from the first or the second user input device, and to translate the first input, the second input, or the third input into the one or more commands to maneuver the movable device.

3. The apparatus according to claim 2, wherein the apparatus is a remote toy controller, and the remote maneuver module is to translate a combination of at least two inputs from the first user input, the second input, and the third input into the one or more commands.

4. The apparatus according to claim 1, further comprising:
an antenna, coupled to the remote maneuver module, to facilitate the one or more commands to be transmitted to the movable device;
a switch, coupled to the remote maneuver module, to enable the remote maneuver module to be powered on or off; or
a battery compartment, enclosed in the elongated body, to accommodate a battery.

5. The apparatus according to claim 1, wherein the first or the second user input device comprises a wheel, a joystick, or a touchpad.

6. The apparatus according to claim 1, wherein the sensor comprises a selected one of a gyroscopic sensor, an angle sensor, or an accelerometer.

7. The apparatus according to claim 1, wherein the remote maneuver module is to use the one or more commands to control a disposition and a course of the movable device in a physical three-dimensional space.

8. The apparatus according to claim 1, wherein the remote maneuver module is to translate the first or second input into a maneuver command to control an altitude of the movable device.

9. The apparatus according to claim 1, wherein the remote maneuver module is to translate the first or second input into a maneuver command to control the disposition of the movable device.

10. The apparatus according to claim 1, wherein the remote maneuver module is to translate the second input into a user gesture to maneuver a speed or a course of the movable device.

11. A method, comprising:
receiving, by a controller, a first input from one or more sensors indicating a disposition or a pattern of movement of a distal end in relation to a proximal end of an elongated remote maneuver controller hosting the controller;
receiving, by the controller, a second input from a physical control unit on the remote maneuver controller, wherein the second input is generated by operation of a first and a second user input device on substantially opposite sides of the elongated remote maneuver controller, the elongated remote maneuver controller to be held by one hand of a user during operation;
translating, by the controller, a combination of the first and second inputs into one or more commands to maneuver a disposition and a course of a movable device; and
transmitting or causing to be transmitted, by the controller, the one or more commands to the movable device.

12. The method of claim 11, wherein receiving a first input comprises receiving the first input based on at least one gyroscopic sensor or an accelerometer on the elongated remote maneuver controller.

13. The method of claim 11, wherein receiving the first input comprises receiving the first input indicating a gesture based on the pattern of movement of the distal end; wherein translating comprises translating the gesture and the second input into one or more commands.

14. The method of claim 11, wherein receiving the second input comprises receiving the second input from a wheel or a joystick on the elongated remote maneuver controller.

15. The method of claim 11, wherein receiving the second input comprises receiving the second input based on a tactile sensor or a capacitive sensor associated with a touchpad on the elongated remote maneuver controller.

16. The method of claim 15, wherein receiving the second input comprises receiving the second input based on a location, a pressure, or a moving pattern detected by the tactile sensor or the capacitive sensor associated with the touchpad.

17. The method of claim 11, wherein translating comprises translating the first input into a speed or the course of the movable device.

18. The method of claim 11, wherein translating comprises translating the second input into a maneuver command to control an altitude or the disposition of the movable device.

19. At least one non-transient computer-readable storage medium, comprising:
a plurality of instructions configured to cause an apparatus, in response to execution of the instructions by the apparatus, to practice the method of claim 11.

20. A system, comprising:
a movable device; and
a remote controller to remotely maneuver the movable device; the remote controller including:
an elongated body having a distal end and a proximal end, wherein the elongated body is to be held by one hand of a user during operation;
a first user input device and a second user input device coupled to the elongated body on opposite sides of the elongated body, the first and second input devices having approximately a same distance to the proximal end;
a sensor coupled to the elongated body to sense a disposition and a movement of the distal end in relation to the proximal end;
one or more computer processors; and
a remote maneuver module, communicatively coupled to the one or more processors and coupled to the elongated body, to determine one or more commands to maneuver a movable device, wherein the remote maneuver module is to:
receive a first input from the first user input device, a second input from the second user input device, or a third input from the sensor; and
translate the first input, the second input, or the third input into the one or more commands to maneuver the movable device.

21. The system according to claim 20, wherein the remote maneuver module is to use the one or more commands to control a disposition and a course of the movable device in a physical three-dimensional space.

22. The system according to claim 20, wherein the remote maneuver module is to translate a combination of at least two selected inputs from the first input, the second input, and the third input into the one or more commands.

23. The apparatus according to claim 1, wherein the first and the second user input device are configured to be controlled by a thumb and an index finger respectively of the one hand of the user during operation.

24. The apparatus according to claim 1, wherein the first and the second user input device have approximately the same distance to the distal end.

25. The system according to claim 20, wherein the first and the second user input device are configured to be controlled by a thumb and an index finger respectively of the one hand of the user during operation.
